(19) United States
(12) Patent Application Publication
(10) Pub. No.: US 2007/0150349 A1
(43) Pub. Date: Jun. 28, 2007

(54) Method and system for culling star performers, trendsetters and connectors from a pool of users

(75) Inventors: Sean Handel, Moss Beach, CA (US); Patrick Grady, San Francisco, CA (US); Mark Orttung, Menlo Park, CA (US); Dan Kikinis, Saratoga, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc.

(21) Appl. No.: 11/479,097

(22) Filed: Jun. 30, 2006

Related U.S. Application Data
(63) Continuation-in-part of application No. 11/321,769, filed on Dec. 28, 2005.

(51) Int. Cl. G06Q 30/00

(52) U.S. Cl. 705/14

(57) ABSTRACT

In one embodiment, method that can be performed on a system, is provided to take not just a person's time and location into consideration, but also has knowledge of and takes into account their availability, their preferences, their schedule, their purpose for being at their current location, and/or their next goal or stop (not just in terms of location but also in terms of activity). One embodiment is able to take into account a real-time view of supplier inventory and deduce and make available much better-adapted offerings and support for that person's travels and endeavors.

### RELATED APPLICATIONS

The present application is a continuation-in-part of U.S. application Ser. No. 11/321,769, entitled “Method and System for Prediction and Delivery of Time-and Context-Sensitive Services,” filed Dec. 28, 2005 (Attorney Docket No. 76840-203801/US) which is incorporated herein by reference.

### BACKGROUND OF THE INVENTION

Location-based systems for tracking and mapping the movements of a subject are not new. They have generated more publicity and speculation than products, but some systems are currently available. These current systems rely mainly on technologies such as global positioning system (GPS) technology, such as Locate911, GPS/911, NAVSTAR GPS, or other equivalent technologies. They can give the identity of a person, the time, and their location. But while some services work globally, without regard to network or location on Earth, others are restricted to a specific network and or specific coverage locations. Some services use such technology to provide, for example, interactive network-based driving instructions. Rather than offering a car-based satellite navigation system, such a service uses a phone, usually a cell phone, to send its GPS information periodically to a server, which then uses that information to send maps of the current location, such as a street or other locator, back to the phone. Thus a user may enter (into said device) a target location and the phone can then display and guide the user through a route to the target. Other systems may provide people with auxiliary services such as, for example, a selection of restaurants nearby.

Making offers to an individual may also have further benefit to the offering entity if the individual receiving the offer is allowed to invite other parties into the offer, as a “friends and family” program.

### SUMMARY

In one embodiment, method that can be performed on a system, is provided to take not just a person's time and location into consideration, but also has knowledge of and takes into account their availability, their preferences, their schedule, their purpose for being at their current location, and/or their next goal or stop (not just in terms of location but also in terms of activity). One embodiment is able to take into account a real-time view of supplier inventory and deduce and make available much better-adapted offerings and support for that person's travels and endeavors. In one embodiment, having an understanding of a rate of conversion and its relation to traffic and weather patterns allows service providers to make more accurate predictions about various items, including but not limited to, conversion rates, offer types, offer upgrades, traffic etc.

In another aspect of the invention, the information collected from many travelers, and also information collected from airlines and weather observers, etc., can be used to forecast inventory requirements, such as obtaining and preparing fresh food and pulling from storage chilled or frozen food, as well as man power or staffing level requirements, to meet projected demands.

In another aspect of the invention, a method is provided to viably distribute these offers to increase the number of potential customers using such a program, without increasing effort and cost. A viable friends and family extension to a limited-time offer system is provided, wherein the recipient of an offer has the ability to invite interested parties or groups, such as friends and family members, to participate in that special limited-time offer.

In yet another aspect of the invention, a system and method are provided to identify trendsetters by following the number of responses they can invoke, and make special offers to such trendsetters wherein they receive additional special offers or promotions or even payments for themselves for generating responses from other people in the process. Also, further, based on certain selection criteria, people responding to secondary offers may be further interested in becoming members, or they may be offered a direct membership to receive promotions themselves.

### BRIEF DESCRIPTION OF THE FIGURES

FIG. 1 presents an exemplary time-and-location graph, mapping the travels and activities of a person, in accordance with one embodiment;

FIG. 2 presents a time-and-location graph that shows the plane-change portion of the trip, in accordance with one embodiment;

FIG. 3 shows an overview of the architecture of one embodiment of a system;

FIG. 4 illustrates an example travel environment;

FIG. 5 illustrates a graph of traffic variations at service provider;

FIG. 6 provides a diagram of a process flow that could be used to analyze the conversions, in accordance with one embodiment.

FIG. 7 illustrates a graph of traffic variations at service provider;

FIG. 8 provides a diagram of a process for calculations in support of forecasting, in accordance with one embodiment;

FIG. 9 shows a diagram of a method and system of offer distribution, in accordance with one embodiment;

FIG. 10 shows a simplified flow diagram of a process of distributing an offer, in accordance with one embodiment;

FIG. 11 shows an exemplary flow diagram of the process of distributing an offer, in accordance with one embodiment;

FIG. 12 shows a exemplary diagram of offer distribution, in accordance with one embodiment;

FIG. 13 shows as an example the limited number of responses that may come from various points in the hierarchy of the distribution tree, in accordance with one embodiment;

FIG. 14 illustrates a histogram, in accordance with one embodiment; and

FIG. 15 presents a flow diagram of an offer-analysis process, in accordance with one embodiment.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

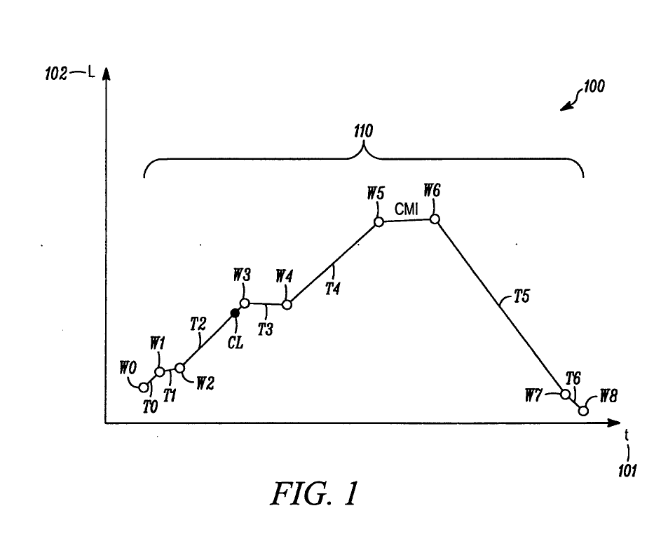

FIG. 1 shows an exemplary time-and-location graph 100, mapping the travels and activities of a person. Locations are plotted along vertical axis l 102, and times are plotted along horizontal axis t 101. Way points W0-W8, which are locations where a person has some planned activity that relates to their business or their travel, and meeting segment M1 lie along travel segments T0-T6. For example, the travel segment T3 between points W3 and W4 could be when and where a traveler changes planes in O'Hare Airport in Chicago, moving between his arrival gate, which in this example is W3, and his departure gate, which in this example is W4. The traveler arrives on a plane whose flight is travel segment T2, and he must depart on another plane whose flight is travel segment T4. His location, which, in this example, is his current location CL, is on the arrival path into the airport, as indicated by the placement of CL on travel segment T2.

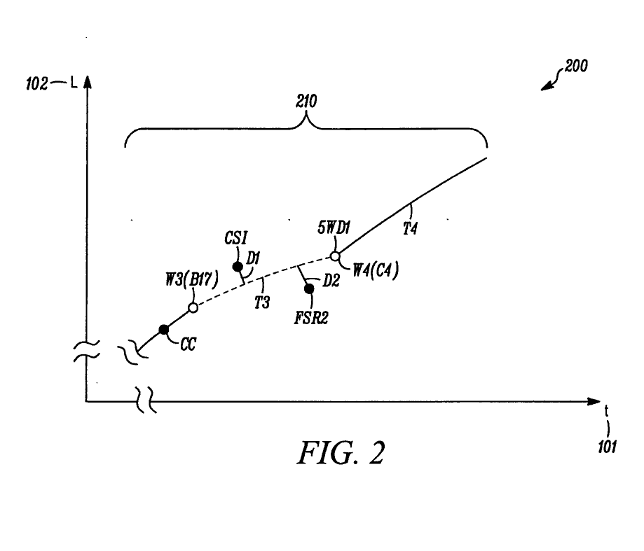

FIG. 2 is a time-and-location graph 200 that shows the plane-change portion of the trip mentioned as an example in the description of FIG. 1, above. Current location CL is shown in magnified graph section 210. Way point W3 could be, for example, gate B17, where the traveler arrives, and way point W4 could be gate C4, where he is scheduled to depart. Thus the traveler must walk, in this case, from W3 to W4, along travel segment T3. Along this segment lie a coffee shop CS1, for example, or a full-service restaurant FSR2, at certain distances D1 and D2 from point W3. With the predictive context-sensitive awareness system of this invention, the traveler's phone could tell him that he does not have food service on his next flight and could also tell him the location of restaurants CS1 and FSR2 in the path between gates, basing the selection of these two restaurants for his information on his past preferences. In addition, based on merchant agreements for priority listings, various food merchants in the airport may receive notification of the traveler's future planned and current activity, so in real time/dynamically, or in the future, these merchants could offer the traveler a discount coupon to attract him to their business, or could send him an online menu so he could, for example, view the menu and order food to be ready when he arrives, either for on-site consumption or to go for his next flight. Further, referring to his preferences and past behavior, the system may submit only certain of these offers to him.

Additionally, in one embodiment a real-time/dynamic link to the supplier's inventory system affects which offers are made by suppliers. For example, a café might have twice the expected inventory of chocolate chip cookies, which can't be sold beyond four hours from time of baking. Based on this inventory level, the supplier system would offer free chocolate chip cookies to passers by until the inventory level reaches the supplier's expected levels again, at which point the offers would stop.

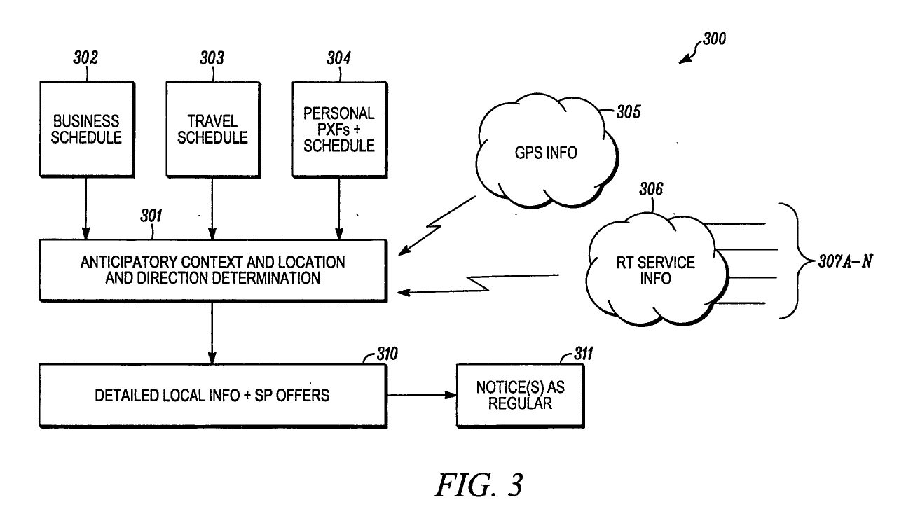

FIG. 3 shows an overview of the architecture of one embodiment of a system 300. The anticipatory context and location-sensitive and direction-determination system 301 is using information coming from many source, such as the business schedule 302, the travel schedule 303, and the personal preferences and schedule of the traveler 304. Information also comes from the GPS information from user's device 305 (this may be GPS or other equivalent location technology, herein generally referred to as GPS) and real-time service provider information 306, which may be provided by any of a large variety of service providers in real time through connections 307a-n. In other cases this information may be collected in another section of a service platform and provided directly from there. This information may trickle in based on travel schedules, or it may be returned based on requests specific to the travel schedule being examined. This supplier information would include information on the real-time status of inventory levels and the state of the supplier's yield management system. The information is then processed with detailed local information and service provider offers in section 310, and the results are processed and are sent as notices to the user or to other members of his business team, family, or other involved persons, or to service providers as required.

In one embodiment the individual service events that are booked for a user report relevant events it creates to a centralized system. In one embodiment, the structure for the events generated by services include any of multiple parameters, such as the date and time of the event start; the date and time of the event end; the location (address, airport, train station, etc.) where that event starts; the location (address, airport, train station, etc.) where that event ends; the type of travel between destinations, which may include, but is not limited to, such carriers as airplane, car, and train; the location of travel between destinations, which may include, for example, traveling between, at destination, or near destination; people who are sharing this event (for example, if a limo is booked with two passengers, then those two people would be named); availability of people involved in event; and options such as not available or available via such communication means as mobile phone, work phone, home phone, text messaging, email, or instant messenger.

In other embodiments, the events also include surrounding time periods affected by this reservation. For example, the fact that a traveler has a flight that is scheduled to depart at 4 p.m. means that he is likely to be traveling to the airport for some period of time before that flight departs and will be unavailable for certain things such as phone calls, email or marketing offers. However, if said traveler has a layover between flights, he may be available to receive offers for restaurants in the B concourse at O'Hare offering discounts to him over his mobile phone. In addition, the user should be able to set preferences for each service that indicate how he would like to be available during specific events. For example, the flight service may allow the user to indicate that during the layover period at an airport, he is available via SMS and email, but not by phone. One embodiment allows for a more detailed availability model controlled in part by the user. One embodiment also allows for a detailed analysis of the dependencies between services. For example, if a user changed his flight leaving from SFO, the system could derive from this event list that he probably also wants to change his airport parking service at SFO.

In one embodiment, if a travel line (time and/or place) is changed due to, for example, a late flight, changed plans, or early or late conclusion of business at a certain stop may include, but are not limited to, notification of affected parties, such as a limo service (to reschedule a pick-up time), family and/or friends, a hotel (to reschedule, cancel, or book reservations), a restaurant (also to reschedule, cancel, or book reservations); and making alternate arrangements, based on known preferences, such as booking a limo instead of a cab, booking an earlier or later flight, including seat reservations, arranging a car rental, presenting public transportation routes and schedules with information about getting via shuttle or train from the airport to the hotel, etc. For example, the system may let the traveler know whether a nearby hotel has early check-in available, thus letting the traveler decide whether to proceed to the hotel and take a shower, or shower at the airport lounge, or go to an offsite restaurant.

One embodiment also coordinates offers from businesses and suppliers, based on knowledge of a traveler's stops and route/path, such as special deals, based on known preferences and past spending from businesses more or less along the traveler's path. Suppliers may send a movie, documents, restaurant menu, etc., for the next flight segment, to pick up at the airport, waiting at the gate, or, in the case of digital items, even directly to user's devices such as a mobile phone or personal digital assistant (PDA). For example, a traveler may order a movie or other program in flight, so it can be downloaded and ready when the plane lands, waiting on a DVD or ready for transfer to a memory stick. Further, one embodiment sends the traveler messages with information about the airport, such as whether passing through a security checkpoint is required to get to a certain merchant or for changing buildings, etc., or about the availability of services in and out of the airport security zone (i.e., for a quick meeting with local non-traveler, etc.).

With predictive knowledge of future traffic near their establishment at a given time period, suppliers can prepare in various ways, such as, for example, by ordering appropriate amounts of perishable food, by making special offers based on light traffic (deeper discounts) or heavy traffic (discounts on food to go, to reduce crowding on site). Also, the further a merchant is off the route of a traveler, the more of an incentive the merchant may offer to the traveler to go to his establishment, in addition to a low traffic discount.

One embodiment schedules variable intervals of GPS checking, such as every 15 seconds, 30 seconds, 5 minutes, 1 km, etc. Further, the checking interval may depend on the traveler's location and available services. For example, in an airport, precise location is important because of the many services available in the area, while the location of a car traveling across the Mojave Desert is less critical because there are no services for miles.

The installation of microcells on airplanes facilitates cell phone GPS and predictive services as described herein. Further, one embodiment use subsets of microcells (IP addresses), to ascertain the traveler's location very specifically; for example, on a particular flight, or at some other specific location. Thus by checking the traveler's ID and having knowledge of his plans and schedule, one embodiment ensures that he is in the right place at the right time, e.g., at the right gate for the correct flight. Alternative embodiments may apply to other situations besides airplanes, including but not limited to cars, busses, boats, trains etc.

As the system detects changes or deviations from the predicted itinerary, the offers of service are adjusted accordingly, in one embodiment. For example, if a traveler's flight is cancelled and the traveler is rebooked on a flight early the next morning, the system could offer bookings at nearby hotels.

One embodiment includes countermeasures to prevent unauthorized knowledge of the user's ID, for security purposes.

In one embodiment payment options, such as the use of credit cards such as American Express, VISA, Master Card, etc., and payment services such as PayPal, because they are accepted universally, even by small businesses. Thus, codes for discounts and promotions delivered to the user can be applied to credit card charges.

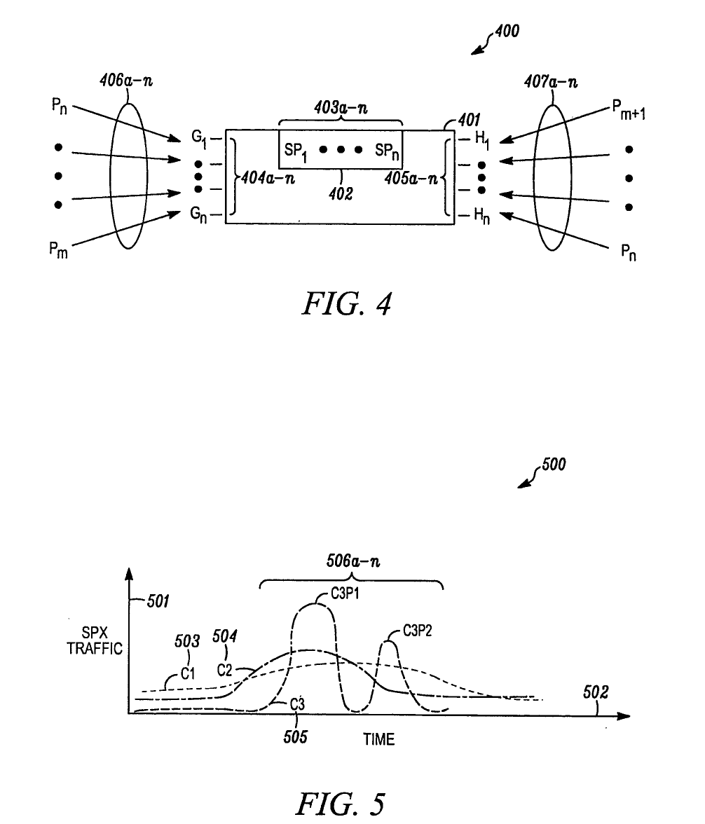

FIG. 4 shows an example travel environment 400. It is clear that this travel environment is only exemplary and other kinds of environments are also applicable, including those examples given above, but for purposes of clarity and simplicity the focus shall be on this example environment. Terminal 401 is a typical commercial airline terminal, with two sets of gates G1-Gn 404a-n and H1-Hn 405a-n. There is also food court 402 with a concentration of service providers SP1-SPn 403a-n. Planes P1-Pn come from both sides, as indicated by arrows 406a-n and 407a-n. In such an environment, most airline flights are typically to or from a hub terminal, wherein travelers arrive and then leave again on connecting flights within a very short period of time.

FIG. 5 shows a graph 500 of traffic variations at service provider SPx. The traffic quantity is shown on the vertical axis 501 and the time range is shown on the horizontal axis 502. Three example traffic curves are shown: curve C1 503, curve C2 504, and curve C3 505. Each curve has a different peak, or peaks, in the peak area 506a-n. For example, curve C1 has a flat spread, in the case that the arrival and departure of planes is spread over a wider range of time, due perhaps to intentional scheduling and also to early and late arrival of some planes; while curve C2 shows a medium peak, with tighter scheduling but also with a few flights being delayed and others being early, resulting in a more condensed peak traffic; and curve C3, due to, for example, schedule changes or weather-related problems in some part of the country, has two very sharp peaks C3P1 and C3P2. Depending on various conditions, such as scheduling and weather, as well as the amount and availability of food on the airplanes, the rate of conversion of offers tendered to travelers for goods and services at the terminal into sales may change, because people, if given a choice between having a snack and catching the next flight, will normally opt for catching the next flight. Having an understanding of the rate of conversion and its relation to traffic and weather patterns allows service providers to make more accurate predictions about various items, including but not limited to, conversion rates, offer types, offer upgrades, traffic etc.

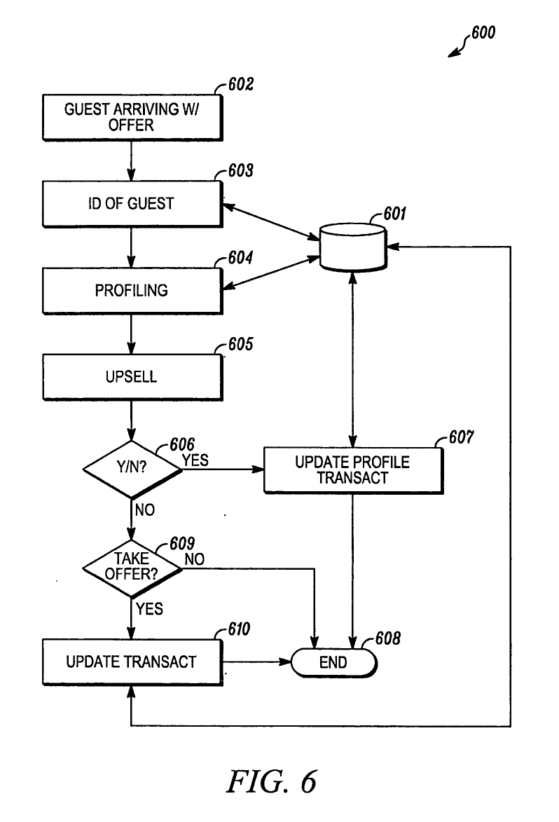

FIG. 6 is a diagram of a process flow 600 that could be used to analyze the conversions. In process 602, a guest arrives at the service provider with an offer (typically, for food or other merchandise, or for a service). In process 603, a guest's ID is compared to information stored in database 601, which could be a local database, or part of a larger remote database, or two synchronized databases, or some combination of the these. In process 604 the profile information about the registered guest (i.e., traveler) is extracted from database 601, then used to update the profile. In particular, You download the profile to do what ever you do, then you may want to update what it is that you have done (e.g. a new offer), and possibly what the customers reaction to that offer was etc. In process 605, an up-sell (upgrade of the offer) may be offered to the guest. At process 606, the process branches. If the guest accepts (YES), the process moves to process 607, where the transaction takes place and the guest profile is updated in database 601, and then to process 608, where the process ends. If, in process 606, the guest does not accept the up-sell (NO), the process moves to process 609, where it again branches. If the guest accepts the original offer (YES), in process 610 the transaction takes place, the guest profile is updated (in some cases, the supplier database may be updated as well) in database 601, and the process moves to process 608, where it ends. If the guest does not accept the original offer (NO), the process ends at process 608.

Additional information, including but not limited to, conversion rates by flight, day of the week, season, weather, flight size, flight utilization, etc., may be collected by individual service providers and then pulled together for further analysis and refined prediction models, allowing more targeted offers. Many modifications can be made without departing from the spirit of the invention. In some cases, for example, the service providers may have their own systems interface with the system of the present invention. In other cases, a solution may be extended by the operator of such a system, offering a complete solution based on a simple terminal device, or in yet other cases, a system may be offered by a credit card or other business service provider, as part of a larger package.

In yet another aspect of the invention, the information collected from many travelers, and also information collected from airlines and weather observers, etc., can be used to forecast inventory requirements, such as obtaining and preparing fresh food and pulling from storage chilled or frozen food, as well as man power or staffing level requirements, to meet projected demands.

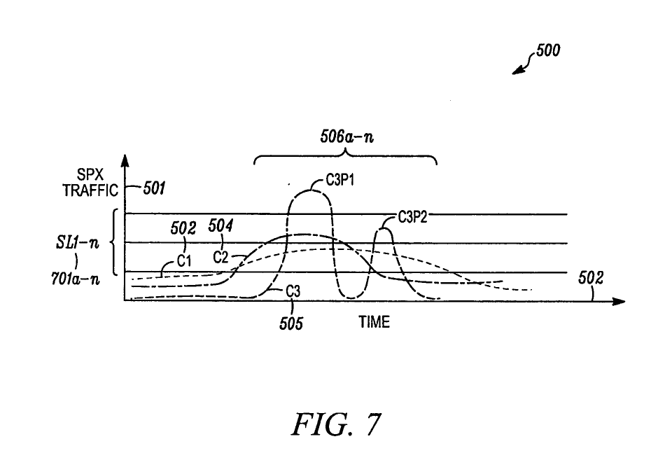

FIG. 7 shows a traffic graph with many of the same elements as FIG. 5 (see description, above). What has been added are horizontal lines indicating staffing levels SL1-n 701a-n. Thus when traffic peaks to the next line SLn, a higher staffing level would be required. Hence calculations must be made to forecast staffing levels some time ahead of the forecasted peak traffic, because people need notice to come to a work place. In a similar manner, forecasted food requirements must be calculated; for example, how many rolls need to be prepared and baked so there are freshly baked rolls when customers arrive at peak traffic times, etc.

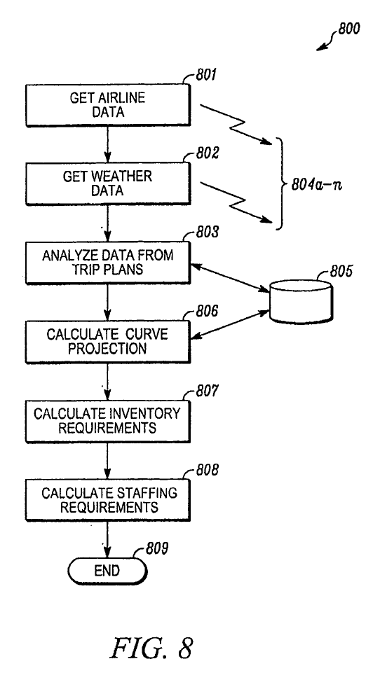

FIG. 8 is a diagram of a process flow 800 for calculations required for the types of forecasting discussed above. In step 801 the system obtains airline data, such as arrival and departure times, both actual (real-time) information and statistical models, as well as usage of the airplane and the airplane model, allowing the system to estimate the number of people expected at a certain time. The data is obtained via communication lines 804a-n, which may connect to a local or remote database in the system, or to both, or directly to a service provider. The weather data is collected in a similar manner in step 802, including, but not limited to, weather data from each flight's point of origin and weather data at the current airport location, because weather experienced at the beginning, during, and end of the flight may impact how travelers feel; whether they are more or less thirsty and/or hungry. Cold and rainy weather may promote the use of warm “comfort foods” while hot and dry weather promotes lighter foods and cold drinks, smoothies etc. This may also be modified by where travelers go to or come from, as the expectation of weather at the end of a trip, or just experienced weather a short while ago may impact how travelers feel about what food they desire. Large statistical gathering, preferably by demographics as well, may allow to cull meaningful data allowing to make better predictions, and hence reduce potential waste. In step 803, data is analyzed from known members, typically the registered travelers using the service (but in some cases, that may include planes, or groups of travelers including non-registered ones etc.) that have a well known track record. This information of these “well-known” or “bell weather” travelers can then be extrapolated, particularly in cases of insufficient statistical data for a current event, using also correlation to other information, including, but not limited to, historic data on weather, plane timeliness, plane capacity and usage, etc., some of which may be also stored in DB 805. All this information is then used in step 806 to calculate forecasted curves of required resources (inventory and man power). The system may not calculate just one curve, but multiple curves; for example, one each for multiple types of inventory, one for staffing level, and one each for other similar resources required by the service provider. In step 807 the actual requirements for each inventory item are calculated, with quantities given in ordering lots; for example, the rolls would be calculated by the tray, or fresh fruit would be calculated by the case, etc. In step 808, also according to the curves, the staffing level is likewise calculated, so that if necessary additional workers may be called in as auxiliary staff (not shown). In step 809, the process ends.

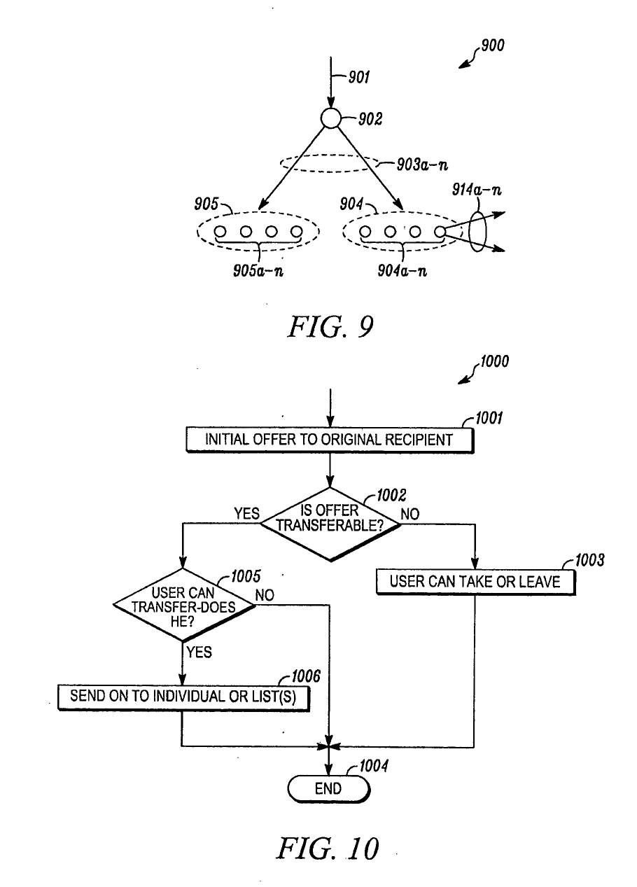

FIG. 9 shows a diagram of a method and system of offer distribution 900. The initial offer 901 is sent to the original offer recipient 902, who then may send one or more invitations 903a-n to individuals or groups such as groups 904 and 905, each comprising a multitude of individuals 904a-n and 905a-n. In some cases, the offer may allow those secondary recipients 904a-n and 905a-n to extend invitations further to any other subgroups 914a-n.

FIG. 10 shows a simplified flow diagram of a process 1000 of distributing an offer, as described above. In process 1001, an initial offer is made to a recipient, which in this example is a traveler, as mentioned earlier. At process 1002, process branches, depending on whether or not the offer is transferable. If the offer is not transferable (NO), the recipient decides whether to take or leave the offer in process 1003, as also described earlier, and the offer distribution process terminates at process 1004. If the offer is transferable (YES), the process moves to process 1005, where it branches again, depending on whether the initial recipient of the offer actual does transfer it. If the recipient does not transfer the offer (NOT), the distribution process then terminates at process 1004. If the recipient does transfer the offer (YES), he may send the offer on to selected individuals or distribution lists in process 1006, and then the distribution process terminates at process 1004. In some cases, the recipient may first accept the offer and later also distribute it (not shown). In yet other cases he may first distribute it, then later accept it himself (also not shown). It is clear that whether the recipient decides to even consider passing on an offer, and also to whom he may pass it on, depends on the type, location and period of validity of an offer, in addition to its attractiveness and other possible considerations. In some cases, the recipient may offer it to travel companions; in other cases, depending on the type of offer; he may send it to the folks back home. In yet other cases, the offer may give him, for example, a bigger discount, based on how many people he reaches in other areas etc.

In one example, when the user forwards on the offer, the offer management system can be informed by including a URL, or in other cases a return receipt or other, similar asynchronous message back to the offer management system. In some cases, the offer management system manages or tracks the state of the offers. This tracking or managing can be done in real time, and allows to see how far and how fast the offer has spread throughout the network. This information is very valuable. It could be used, for example, to allow the supplier to use this real time view to determine whether or not to send out additional offers. Also, in some cases, as a type of yield management, the pricing of the offers by the offer management system could be determined or modified according to the number of offer forwards done or by the total number of people to whom the offer was forwarded, or how fast people start to forward it, indicating how valuable it is perceived.

Further, in some cases, each offer may be coded as a “use once” or “use many” type of offer. A “use once” offer can only be used by one of the people in the chain. Once it is used, none of the others may use it. A “use many” offer can be passed along and used by any number of people. There are other variations such as putting a specific number of uses (1-n) or a specific timeframe for use (February 1st to February 24th, for example). An offer may be “degraded” as it is passed along (for example, starts out as 20% discount and decrements by 1% for each additional user it is passed along to (19%, then 18%, etc.) This model will allow for other such types of restrictions as well. As mentioned above, implementing at least part of the offer through a web mechanism in some cases allows to dynamically control the offer value, as well as tracking it. For example the discount number may be embedded as a hyperlink and supplied by a WEB server, and a cookie on the client may identify the user viewing the message, and hence the appropriate discount.

Similarly, in some cases the offer to the original person may increase in value based on the number of people who have accepted an offer he or she passed along. For example, an offer initially worth a 10% discount may increase by 1% for each downstream person who actually takes the supplier up on the offer forwarded by the original person. This increase in value may be unlimited or it may be capped. For example, the original 10% offer may be capped at 20%, regardless of whether more than 10 downstream people take advantage of the offer.

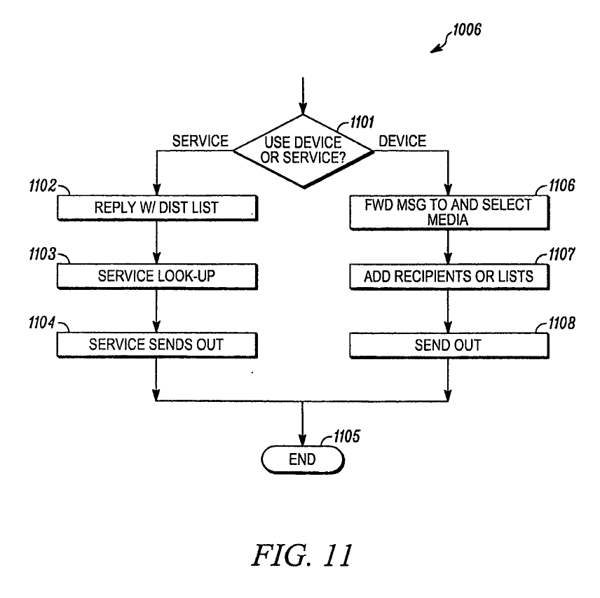

FIG. 11 shows an exemplary flow diagram of the process 1006 of distributing an offer. For example, the first process may be process 1101, where the original recipient may choose to use a device (“his device”), such as a phone, data organizer, etc., or, alternatively, a service to extend the offer. In the case of using a device, he may rely solely on features of his device to re-distribute the offer. The recipient's ability to distribute the offer may be limited to both address directories as well as media (or message) types (including but not limited to email, SMS, IM, social site(s), etc.) available on his device. If the recipient decides to use a service, as shown in process 1102, he may reply to the service provider (typically the entity that sends the original offer or a contractor or similar of that entity) who made the offer. For example, he could reply with the name of a pre-stored distribution list in the subject line (or it could be inserted in the body of the message). In yet other cases, a link might be provided for each available list etc. In process 1103 the service provider then makes a look-up and interprets this list or these addresses, and in process 1104 the service provider sends out invitations to the individuals or members of the groups indicated in process 1102. The service may send the invitation in its own name, or it may send it on behalf of the recipient who responded with the distribution list, or the service provider may even send invitations directly in the name of the original recipient. The list may also contain specific media in which to send out a message, including but not limited to email, SMS, IM, social site(s), etc. If, in process 1101, the offer recipient chooses to use his device to forward the offer, he can then select, in process 1106, the individuals and/or groups to whom to forward a message, and he may also select the media in which it is forwarded. For example, in a message received in SMS may be forwarded as an email instead of SMS, because email has better tools for managing lists, added comments etc. Also, not all recipients may be using or have access to a mobile device, etc. In process 1107, recipients or lists are added to the forwarded message, and in process 1108, the message is sent out.

It is clear that many modifications and variations of this embodiment may be made by one skilled in the art without departing from the spirit of the novel art of this disclosure. For example, in some cases, the user may use a mix of service- and device-based forwarding. In other cases, he may have lists organized by media, groups, etc. In yet other cases, the service provider may create a list of “known contacts” (i.e., contacts in address book etc.) that are traveling that day, as a type of dynamic social networks and so forth.

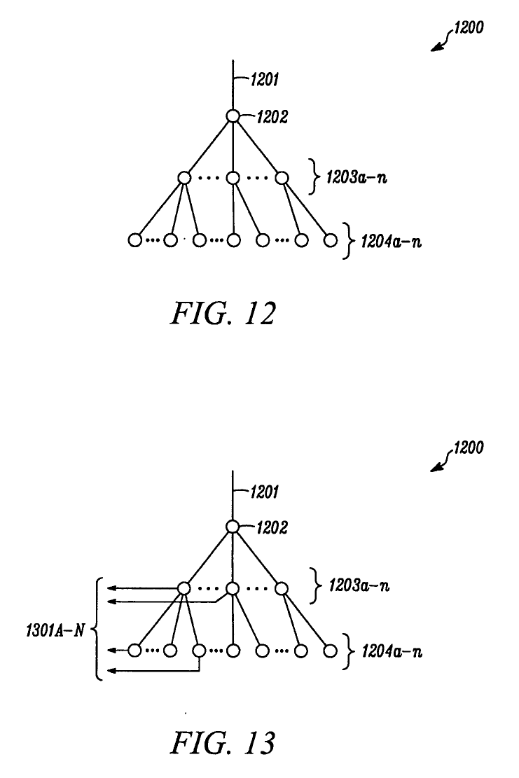

FIG. 12 shows a simplified exemplary diagram of offer distribution 1200. Initial offer 1201 is sent to initial recipient 1202, who in turn can send the offer to secondary recipients 1203a-n. In turn, these secondary recipients may send the offer to other recipients 1204a-n, and so forth. This is a viral marketing scheme These offers may be sent to many users of the system based on their travel information, as described earlier.

FIG. 13 shows as an example the limited number of responses 1301a-n that may come from various points in the hierarchy of the distribution tree 1200.

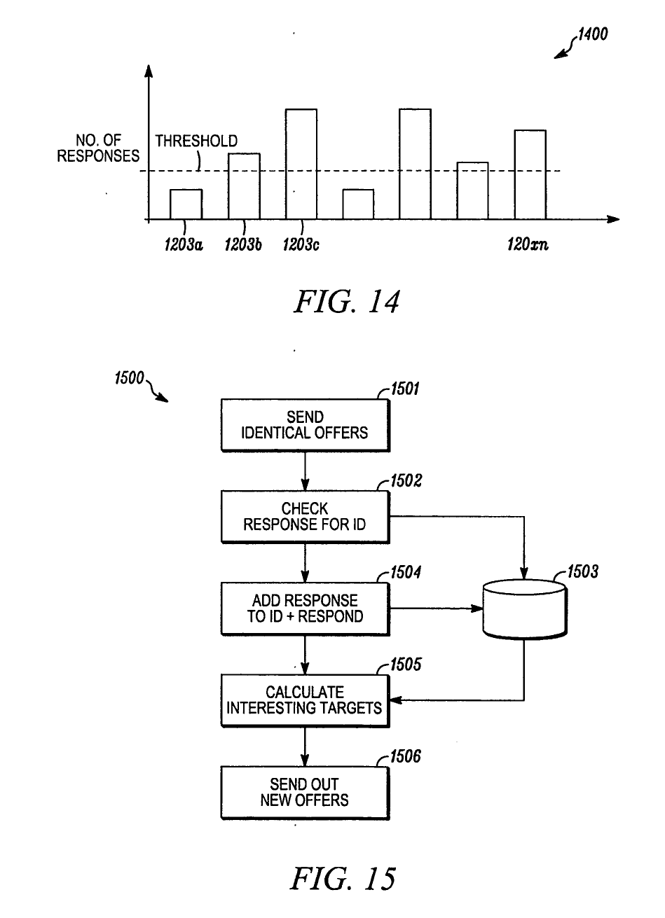

The points of response may be analyzed by, for example, creating a histogram 1400, such as that shown in FIG. 14, where the respondents are listed as 1203a through 120xn, including the whole distribution tree (all respondents thereof). For each identified respondent, the number of responses to repeated offers above a certain threshold may identify how likely this person is to respond. Specific performers, such as 1203b, 1203c, and others may be given an offer to join directly (for example to subscribe to the service). In yet other cases, respondents with particularly high sub-respondent activity rates may be pointed out for special offers directly. For example, the email trail may be analyzed for the transmission paths, and therefore even second- or third-layer respondents may be traced back to a first layer respondent in a 1203a layer, and hence those original respondents may be given a higher-trendsetter priority. In yet other cases, rather than analyzing just the number of responses alone, speed of responses generated and or total amount of the generated sub-responses, as well as type of responses may also be used to create a ranking (not shown here).

FIG. 15 is a simplified flow diagram of an offer-analysis process 1500. In step 1501, an initial offer is sent out. Responses are analyzed for IDs of trendsetters in step 1502, and the data is stored in database 1503. A histogram is generated in step 1504, showing how many primary and secondary respondents have had additional tertiary responses, and that data also is stored in database 1503. In step 1505, based on certain rules, the data from database 1503 is used to calculated targets of interest, and, in step 1506, additional new offers are sent to the identified targets.

By trying to map the flow of information beyond the original recipient, very active individuals, who act as connectors or trendsetters in the transmission tree, may be discovered. In some cases, it may be advantageous to distinguish between trendsetters and connectors. Trendsetters are the ones who can be viewed as early adopters of such offers. Connectors are those who are very good at disseminating offers out to a wider audience. Based on historical information, one can determine which ones are accurate predictors of an offer's success.

These trendsetters and or connectors may have a high value as members of a viral marketing system. Over the course of many repetitive offers, and combining the data of millions of offers, it may become clear who those trendsetters and or connectors are, as they may appear in more than one tree of more than one respondent. By mapping communication addresses, as well as time of responses and other factors in the response patterns, a very detailed map can be created showing the flow and distribution of information. By comparing those data for different types of offers and different demographics, different trendsetters may be highlighted for different types of campaigns, based on demographics, type of offer, etc. This identification of trendsetters and or connectors may help create very valuable marketing network information, as new offers may be sent targeted to the most appropriate trendsetter, hence increasing the chances of success dramatically.

In some cases, offers may be given also in a format suitable for Blogs. (common abbreviation for Web-logs)

It is clear that many modifications and variations of this embodiment may be made by one skilled in the art without departing from the spirit of the novel art of this disclosure. Additional information, including but not limited to, resource requirements by flight, day of the week, season, weather, flight size, flight utilization, etc., may be collected by individual service providers and then pulled together for further analysis and refined prediction models, allowing more targeted resource predictions. Many modifications can be made without departing from the spirit of the invention. In some cases, for example, the service providers may have their own systems interface with the system of the present invention. In other cases, a solution may be extended by the operator of such a system, offering a complete solution based on a simple terminal device, or in yet other cases, a system may be offered by a credit card or other business service provider, as part of a larger package.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

What is claimed is:

1. A method comprising:
dynamically providing a first offer to a first user's mobile device, the offer based on the first user's location or expected location during a first period of time, and the first user's availability during the first period of time;
providing in the first offer a second offer to have the first offer extended to one or more additional offerees; and
Classifying one of the first user or one of the additional offerees, based on a predetermined criteria related to at least one of additional responses invoked or a type offer accepted.

2. The method of claim 1, further comprising providing one or more of an offer, promotion, or payment in response to invoking additional responses.

3. The method of claim 2, the offer, promotion or payment based on a classification of the offeree of the offer, promotion, or payment.

4. The method of claim 1, wherein the predetermined criteria is a quantity of additional responses invoked.

5. The method of claim 1, wherein the predetermined criteria includes invoking one or more responses within a predetermined period of time.

6. The method of claim 1, wherein the predetermined criteria includes invoking a predetermined quantity of responses within a predetermined period of time.

7. The method of claim 1, wherein the predetermined criteria includes a combination of a quantity of additional responses and a timing of additional responses.

8. The method of claim 1, wherein the predetermined criteria includes receiving responses to a pre-identified type of offer.

9. The method of claim 1, further comprising generating a ranking of identified trendsetters based at least on one of quantity, timing, or responses to a predetermined type of offer.

10. The method of claim 9, further comprising issuing one of promotions, payments, or additional offers to a trendsetter based on a relative ranking of the respective trendsetter.

11. The method of claim 5, further comprising offering, based on predetermined criteria, a membership to at least one of the additional offerees.

12. The method of claim 11, wherein the membership includes the additional offeree receiving at least one of offers, promotions, and payments directly.

13. A machine readable medium having stored thereon a set of instructions which when executed, perform processes comprising of:
dynamically providing a first offer to a first user's mobile device, the offer based on the first user's location or expected location during a first period of time, and the first user's availability during the first period of time;
providing in the first offer a second offer to have the first offer extended to a first group of one or more additional offerees; and
Classifying one of the first user or one of the additional offerees, based on a predetermined criteria related to at least one of additional responses invoked by the first user, or a type offer accepted.

14. The machine readable medium of claim 13, further comprising providing one or more of an offer, promotion, or payment in response to invoking additional responses.

15. The machine readable medium of claim 14, the offer, promotion or payment based on a classification of the offeree of the offer, promotion, or payment.

16. The machine readable medium of claim 13, wherein the predetermined criteria is a quantity of additional responses or acceptances invoked.

17. The machine readable medium of claim 13, wherein the predetermined criteria includes invoking one or more responses within a predetermined period of time.

18. The machine readable medium of claim 13, wherein the predetermined criteria includes invoking a predetermined quantity of responses within a predetermined period of time.

19. The machine readable medium of claim 13, wherein the predetermined criteria includes a combination of a quantity of additional responses and a timing of additional responses.

20. A system comprising of:
a means for dynamically providing a first offer to a first user's mobile device, the offer based on the first user's location or expected location during a first period of time, and the first user's availability during the first period of time;
a means for providing in the first offer a second offer to have the first offer extended to a first group of one or more additional offerees; and
a means for classifying one of the first user or one of the additional offerees, based on a predetermined criteria related to at least one of additional responses invoked by the first user, or a type offer accepted.
